(19) United States
(12) Patent Application Publication
(10) Pub. No.: US 2009/0285663 A1
(43) Pub. Date: Nov. 19, 2009

(54) PILL COUNTING TRAY

(76) Inventor: Darryl Chemel, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 11/915,506

(22) PCT Filed: May 26, 2005
(86) PCT No.: PCT/CA2005/000797

§ 371 Date: Nov. 3, 2008

(51) Int. Cl. A61J 7/02

(52) U.S. Cl. 414/675

(57) ABSTRACT

Most conventional pill counting devices are intentionally designed to be ergonomically comfortable for either right or left-handed users, but not both right and left-handed users simultaneously. In contrast, some embodiments in accordance with the invention provide a pill counting apparatus that is ergonomically comfortable for both right and left-handed users a like. In such embodiments the construction of the pill counting apparatus provides clear and inherent visual queues that enable a user to easily distinguish counted pills from bulk pills. In some embodiments a pill counting apparatus includes a pan with a symmetrically arranged first pouring spout and a tray having a symmetrically arranged second pouring spout, and the first and second pouring spouts are arranged to encourage pouring in different directions from one another.

### FIELD OF THE INVENTION

The invention relates to apparatus for counting pills and the like, and, in particular to pill counting trays.

### BACKGROUND OF THE INVENTION

The most widely used apparatus employed by pharmacists for counting out pills and the like (e.g. tablets, pellets, capsules, lozenges, etc.) is a simple flat counting tray having a collection trough integrally connected along one side of the tray. A well-known example of such a pill counting tray is disclosed in U.S. Pat. No. 2,530,009 to Fields. In use, a bulk supply of pills is poured onto the tray and a desired amount of pills is then counted and pushed into the trough using a spatula. The counted pills in the trough are transferred into a prescription bottle (or similar vessel) preferably without spilling the excess bulk pills remaining on the tray. This seemingly simple task is often botched because even gently bumping and/or nudging the tray may lead to spillage and/or intermixing of the counted pills with the excess bulk pills. Moreover, pill counting trays of the type disclosed by Fields are intentionally configured to be ergonomically comfortable for either right or left-handed users (but not both), as a result of the trough placement along a specific side of the tray.

Another pill counting tray is disclosed in U.S. Pat. No. 4,261,683 to Zaleon. The pill counting tray disclosed by Zaleon has an asymmetric design. The pill counting tray includes first and second identical compartments that are symmetrically arranged into one housing. In use, one of the two identical compartments is used to collect a number of specifically counted pills and the other is used to collect excess bulk pills. The asymmetry of the pill counting tray is essential and is achieved by the addition of first and second pouring spouts that are integrally provided to the corresponding first and second compartments, respectively. The first and second pouring spouts are asymmetrically arranged so as to allow one compartment to be emptied by tilting the whole pill counting tray towards a respective pouring spout, without simultaneously pouring out the pills in the other compartment through the other pouring spout.

The pill counting tray does not provide a user with visual references that can be to distinguish between different groups of pills. Subsequently, a pharmacist may make mistakes when using the asymmetric pill counting tray disclosed by Zaleon. More specifically, during normal use each of the two compartments eventually contains a number of pills that may not always be counted by simple visual inspection. Once the pills are separated into the two compartments it is difficult to visually determine which compartment has the counted pills or the excess bulk pills. This problem expresses itself in two ways during normal use. First, the asymmetric design requires that a pharmacist rotate the tray in order to properly position the tray before the tray can be tilted to pour out the pills in one compartment into another vessel (e.g. a prescription bottle). The rotation of the tray sometimes leads to confusion as to which group of pills is contained in each compartment. Second, a pharmacist may be distracted or interrupted and forget which compartment is being used for each group of pills.

### SUMMARY OF THE INVENTION

According to an aspect of an embodiment of the invention there is provided a pill counting apparatus comprising: a first support surface; and, a second support surface connected to the first support surface, the second support surface elevated over the first support surface, and wherein at least one of the first and second support surfaces has a pouring spout.

In some embodiments the first and second support surfaces have a respective first and second pouring spouts.

In some more specific embodiments the first and second pouring spouts are arranged to pour in different directions away from the pill counting apparatus.

In some embodiments the second pouring spout is defined by upturned corners of the second support surface.

In some embodiments the second support surface includes upturned fins defining the second pouring spout.

In some embodiments the first support surface is provided with a sidewall that, in combination with the first support surface, defines a pan, and the second support surface rests over at least a portion of the open-top of the pan.

In some embodiments the second support surface is connectable to the pan so that one of the second sidewall and the pan is capable of tilting independently of the other.

In some embodiments the second support surface includes a downwardly extending lip that fits around a portion of the sidewall and does not grasp or otherwise securely fix the second sidewall to the pan.

In some embodiments the second support surface is centrally located over the open-top of the pan such that right and left sides of the pan extend out beyond the respective right and left edges of the second support surface, thereby permitting pills on the second support surface to be pushed off of either the right edge or left edge of the second support surface into the pan.

In some embodiments the second support surface is permitted to slide between complimentary right and left positions to ease right and left-handed operation as desired by a user. In some embodiments the side wall further comprises upper fins serving as a side guard to restrict the motion of the second support surface and to prevent pills from spilling out of the apparatus over edges of the second support surface. In some embodiments a portion of the sidewall includes a substantially horizontal lip to support sliding movement of the second support surface. In some embodiments the horizontal lip includes a slide groove to permit and restrict the sliding movement of the second support surface.

In some embodiments the sidewall includes a portion that is formed as a nozzle leading to the first pouring spout.

In some embodiments the second support surface includes a downwardly extending lip having an opening conforming to the nozzle profile of the sidewall through which the nozzle is inserted when the apparatus is assembled.

In some embodiments wherein the second support surface includes a downwardly extending lip which forms as a clip that secures the second support surface to the pan.

In some embodiments the sidewall includes upper fins flanking the first pouring spout and extending towards the interior of the pan. In some embodiments the second support surface includes an upwardly extending lip that, after assembly, fits underneath the upper fins of the pan and is shaped to conform to the interior surface of the sidewall to prevent pills on the tray from sliding through the first pouring spout.

In some embodiments the sidewall is provided with generous chamfers at respective corners of the pan.

In some embodiments some portions of the sidewall curve upwardly and inwardly from the first support surface.

In some embodiments some portions of the sidewall rises upwardly and outwardly from the first support surface.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1A is a perspective view of a first pill counting apparatus according to aspects of an embodiment of the invention;

FIG. 1B is an exploded perspective view of the first pill counting apparatus shown in FIG. 1A;

FIG. 2 is an illustration depicting the use of the first pill counting apparatus shown in FIG. 1A;

FIG. 3A is a perspective view of a second pill counting apparatus according to aspects of an embodiment of the invention;

FIG. 3B is an exploded perspective view of the second pill counting apparatus shown in FIG. 3A; and

FIG. 3C is a top view of the second pill counting apparatus shown in FIG. 3A.

### DETAILED DESCRIPTION OF THE INVENTION

Most conventional pill counting devices are intentionally designed to be ergonomically comfortable for either right or left-handed users, but not both right and left-handed users simultaneously. In contrast, some embodiments in accordance with the invention provide a pill counting apparatus that is ergonomically comfortable for both right and left-handed users a like. In such embodiments the construction of a pill counting apparatus provides clear and inherent visual queues that enable a user to easily distinguish counted pills from bulk pills.

In some embodiments a pill counting apparatus includes a first support surface and a second support surface elevated over the first support surface. At least one of the first and second support surfaces has a pouring spout. In more specific embodiments the first and second support surfaces have a respective first and second pouring spouts that encourage pouring in different directions from one another.

In some embodiments the first support surface is provided with a sidewall that defines a pan in combination with the first support surface. The second support surface rests over at least a portion of the open-top of the pan. In some specific embodiments the second support surface is centrally located over the open-top of the pan such that the right and left sides of the pan extend out beyond the respective right and lefts edges of the second support surface, thereby permitting pills on the second support surface to be pushed off of either the right edge or left edge of the second support surface into the pan.

In other specific embodiments the second support surface is connectable over the open-top of the pan and is permitted to slide between complimentary right and left positions to ease right and left-handed operation as desired by a user. Accordingly, pills are preferably pushed off one of the left or right edges of the second support surface into the pan.

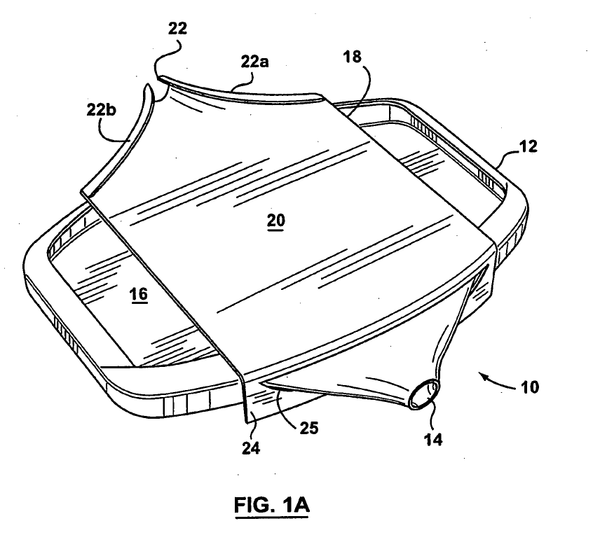

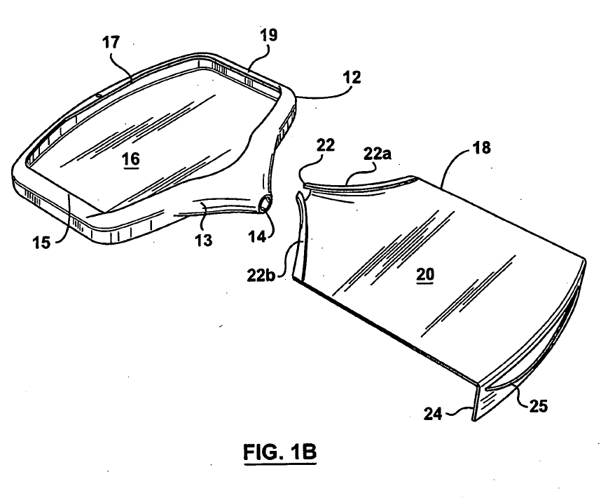

Referring to FIGS. 1A and 1B, shown are a perspective view and a corresponding exploded perspective view of a first pill counting apparatus 10, simply referred to as the apparatus 10 hereinafter for brevity, provided in accordance with one very specific embodiment of the invention. The apparatus 10 includes an open-topped pan 12 and a tray 18 that rests over the open top of the pan 12. In some embodiments the pan 12 is a molded single piece made from plastic or other polymers. Similarly, in some embodiments the tray 18 is a molded single piece made from plastic or other polymers. Those skilled in the art will appreciate that various materials (e.g. wood, metal, fiberglass, cardboard, paper, etc.) may be used in the construction of the pan 12 and the tray 18 without departing from the scope of the claims following this section.

In the very specific embodiment illustrated in FIGS. 1A and 1B, the pan 12 has a generally flat support surface 16 and sidewalls 15, 17 and 19 that curve upwardly and inwardly from the support surface 16. Another sidewall 13, directly opposite to that of the sidewall 17, is connected between sidewalls 15 and 19 and forms a nozzle with a first pouring spout 14 arranged in the middle of the sidewall 13. Consequently, the overall structure of the pan 12 is generally symmetrical. However, those skilled in the art will appreciate that misalignments remain within the scope of the claims that follow this section. Additionally, in some embodiments the corners of the pan 12, where the sidewalls 13, 15, 17 and 19 meet, smoothly merge together to provide a generous chamfer, thereby preventing pills from being lodged between the adjoining sidewalls and to facilitate cleaning of the pan 12. Also, an advantage of having a pan 12, as opposed to a trough (such as disclosed by Fields), is that a pan has more capacity to hold pills than does a trough.

With continued reference to FIGS. 1A and 1B, in this very specific embodiment the tray 18 includes a substantially flat support surface 20, a downwardly extending lip 24 and a second pouring spout 22 defined by upturned corners 22a and 22b of the tray 18. In some embodiments the second pouring spout 22 is arranged along an edge of the tray 18 and, when the apparatus 10 is assembled, is directed in a different direction from the first pouring spout 14 of the pan 12. Precise alignments of the first and second pouring spouts 14, 22 relative to one another and/or a line of symmetry of the apparatus 10 as a whole are not essential, but may add to the overall symmetry and balance of the apparatus 10. In some embodiments the downwardly extending lip 24 includes a formed opening 25 that fits around the nozzle profile of the sidewall 13 in order to hold the tray 18 and the pan 12 fixed relative to one another. Additionally and/or alternatively, the lip 24 may be formed as a clip (not shown) that secures the tray 18 to the pan 12. In other alternative embodiments the downwardly extending lip 24 fits around a portion of the sidewall 13 and does not grasp or otherwise securely fix the tray 18 to the pan 12. In even other alternative embodiments the tray 18 is connected to the pan 12 so as to be capable of tilting independently of the pan 12 and vice versa.

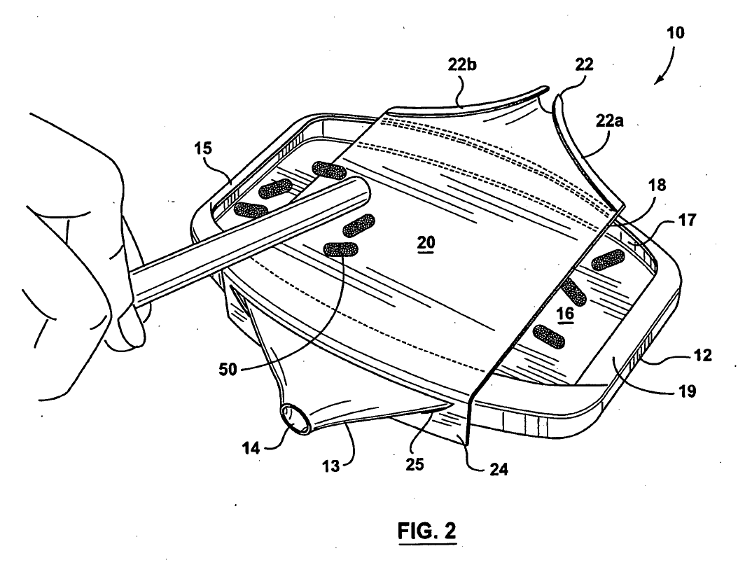

Referring to FIG. 2, and with continued reference to FIGS. 1A and 1B, shown is an illustration depicting the use of the apparatus 10. In use a user (e.g. a pharmacist) places an uncounted number of bulk pills 50 on the support surface 20 of the tray 18, while the counting tray apparatus 10 is positioned in the substantially horizontal orientation shown in FIG. 2. The user counts pills by guiding some of the pills 50 over an edge of the tray 18 into the pan 12. A remaining number of the pills 50 on the support surface 20 of the tray 18 are disposed (e.g. back into a bulk container) by tilting the entire apparatus 10 in the direction of the second pouring spout 22 through which the remaining pills slide due to gravity. The pills in the pan 12 remain in the pan 12 during this operation. The pills in the pan 12 are then dispensed through the first pouring spout 14 by tilting the entire apparatus 10 in the direction of the first pouring spout 14.

Alternatively, a complementary use to that described above is also possible. In accordance with the complementary use the uncounted pills are first pushed into the pan 12. The counted pills are dispensed through the second pouring spout 22. And, finally the uncounted pills are disposed through the first pouring spout 14. Irrespective of which of the two described uses are employed one group of pills will remain on the support surface 20 of the tray 18 and the other group of pills will be in the pan 12. That is, the counted pills and bulk pills are separated in a visually simple clear and distinguishable manner because the two possible locations for a group of pills are dissimilar.

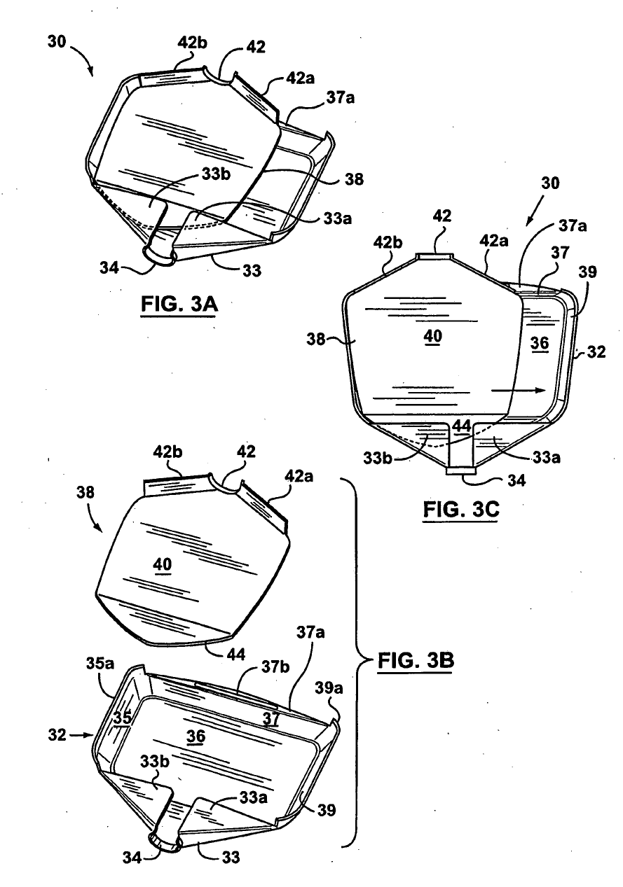

Referring to FIGS. 3A and 3B, shown are a perspective view and a corresponding exploded perspective view of a second symmetric pill counting apparatus 30, simply referred to as the apparatus 30 hereinafter for brevity, provided in accordance with one very specific embodiment of the invention. For further clarity a top view of the apparatus 30 is also provided in FIG. 3C. The apparatus 30 includes an open-topped pan 32 and a tray 38. The tray 38 rests over the open top of the pan 32 so as to slide between left and right positions in order to expose different portions of the open top of the pan 32. In particular, FIGS. 3A and 3C show the tray 38 in the left position over the pan 32.

In some embodiments the pan 32 is a molded single piece made from plastic or other polymers. Similarly, in some embodiments the tray 38 is a molded single piece made from plastic or other polymers. Those skilled in the art will appreciate that various materials (e.g. wood, metal, fiberglass, cardboard, paper, etc.) may be used in the construction of the pan 32 and the tray 38 without departing from the scope of the claims following this section.

The pan 32 has a generally flat support surface 36 and generally flat sidewalls 35, 37 and 39 that rise upwardly and outwardly from the bottom 36. Another sidewall 33, directly opposite to that of the sidewall 37, is connected between sidewalls 35 and 39 and forms a nozzle with a first pouring spout 34 arranged in the middle of the sidewall 33. The sidewall 33 includes upper fins 33a and 33b flanking the first pouring spout 34 and extending towards the interior of the pan 32. The sidewalls 35 and 39 also include upper fins 35a and 39a, respectively, that act as side guards to restrict the motion of the tray 38 and prevent pills from spilling out of the apparatus 30 over the left and right edges of the tray 38. The sidewall 37 as a substantially horizontal lip 37a that includes a slide groove 37b to permit and restrict the sliding movement of the tray between left and right positions.

Similar to the pan 12 described above with reference to FIGS. 1A and 1B, the overall structure of the pan 32, illustrated in FIGS. 3A-3C, is generally symmetrical. However, those skilled in the art will appreciate that misalignments remain within the scope of the claims that follow this section. Additionally, in some embodiments the corners of the pan 32, where the sidewalls 33, 35, 37 and 39 meet, smoothly merge together to provide a generous chamfer, thereby preventing pills from being lodged between the adjoining sidewalls and to facilitate cleaning of the pan 32.

With continued reference to FIGS. 3A-3C, in this very specific embodiment the tray 38 includes a substantially flat support surface 40, an upwardly extending lip 44 and a second pouring spout 42 defined by upturned fins 42a and 42b of the tray 48. In some embodiments the second pouring spout 42 is symmetrically arranged along an edge of the tray 38 and, when the apparatus 30 is assembled, is directed in a different direction from the first pouring spout 34 of the pan 32. Precise alignments of the first and second pouring spouts 34, 42 relative to one another and/or a line of symmetry of the apparatus 30 as a whole are not essential, but may add to the overall symmetry and balance of the apparatus 30. Moreover, also when the apparatus 30 is assembled, the upwardly extending lip 44 fits underneath the fins 33a and 33b and is shaped to conform to the interior surface of the sidewall 33 to prevent pills on the tray from sliding through the first pouring spout 34.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention. Numerous modifications and variations of the present invention are possible in light of the above teachings. It is therefore to be understood that within the scope of the appended claims, the invention may be practiced otherwise than as specifically described herein.

1. A pill counting apparatus comprising:
a first support surface; and
a second support surface connected to the first support surface, the second support surface elevated over the first support surface,
and wherein at least one of the first and second support surfaces has a pouring spout.

2. A pill counting apparatus according to claim 1, wherein the first and second support surfaces have a respective first and second pouring spouts.

3. A pill counting apparatus according claim 2, wherein the first and second pouring spouts are arranged to pour in different directions away from the pill counting apparatus.

4. A pill counting apparatus according to claim 2, wherein the second pouring spout is defined by upturned corners of the second support surface.

5. A pill counting apparatus according to claim 2, wherein the second support surface includes upturned fins defining the second pouring spout.

6. A pill counting apparatus according to claim 2, wherein the first support surface is provided with a sidewall that, in combination with the first support surface, defines a pan, and the second support surface rests over at least a portion of the open-top of the pan.

7. A pill counting apparatus according to claim 6, wherein the second support surface is connectable to the pan so that one of the second sidewall and the pan is capable of tilting independently of the other.

8. A pill counting apparatus according to claim 2, wherein the second support surface includes a downwardly extending lip that fits around a portion of the sidewall and does not grasp or otherwise securely fix the second sidewall to the pan.

9. A pill counting apparatus according to claim 2, wherein the second support surface is centrally located over the open-top of the pan such that right and left sides of the pan extend out beyond the respective right and lefts edges of the second support surface, thereby permitting pills on the second support surface to pushed off of either the right edge or left edge of the second support surface into the pan.

10. A pill counting apparatus according to claim 2, wherein the second support surface is permitted to slide between complimentary right and left positions to ease right and left-handed operation as desired by a user.

11. A pill counting apparatus according to claim 10, wherein the side wall further comprises upper fins serving as a side guard to restrict the motion of the second support surface and to prevent pills from spilling out of the apparatus over edges of the second support surface.

12. A pill counting apparatus according to claim 11, wherein a portion of the sidewall includes a substantially horizontal lip to support sliding movement of the second support surface.

13. A pill counting apparatus according to claim 12, wherein the horizontal lip includes a slide groove to permit and restrict the sliding movement of the second support surface.

14. A pill counting apparatus according to claim 6, wherein the sidewall includes a portion that is formed as a nozzle leading to the first pouring spout.

15. A pill counting apparatus according to claim 13, wherein the second support surface includes a downwardly extending lip having an opening conforming to the nozzle profile of the sidewall through which the nozzle is inserted when the apparatus is assembled.

16. A pill counting apparatus according to claim 10, wherein the second support surface includes a downwardly extending lip forms as a clip that secures the second support surface to the pan.

17. A pill counting apparatus according to claim 6, wherein the sidewall includes upper fins flanking the first pouring spout and extending towards the interior of the pan.

18. A pill counting apparatus according to claim 17, wherein the second support surface includes an upwardly extending lip that, after assembly, fits underneath the upper fins of the pan and is shaped to conform to the interior surface of the sidewall to prevent pills on the tray from sliding through the first pouring spout.

19. A pill counting apparatus according to claim 6, wherein the sidewall is provided with generous chamfers at respective corners of the pan.

20. A pill counting apparatus according to claim 6, wherein some portions of the sidewall curve upwardly and inwardly from the first support surface.

21. A pill counting apparatus according to claim 6, wherein some portions of the sidewall rises upwardly and outwardly from the first support surface.
